(19) United States
(12) Patent Application Publication
(10) Pub. No.: US 2015/0089113 A1
(43) Pub. Date: Mar. 26, 2015

(54) EXPANSION CARD HAVING TWO SWITCHABLE CONNECTORS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: KANG WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/144,607

(22) Filed: Dec. 31, 2013

(30) Foreign Application Priority Data
Sep. 23, 2013 (CN) 2013104340987

(51) Int. Cl. G06F 13/38

(52) U.S. Cl. CPC G06F 13/385
USPC 710/313

(57) ABSTRACT

An expansion card includes a PCIe connector, a non-PCIe connector, a signal switching module, and a signal processing module. The signal switching module includes a signal receiving unit and a signal transmitting unit. The PCIe connector is connected to the signal receiving unit and the signal transmitting unit. The non-PCIe connector is connected to the signal receiving unit and the signal transmitting unit. The signal processing module is connected to the signal receiving unit and the signal transmitting unit. When both of the signal receiving unit and the signal transmitting unit receive a high-level signal, the PCIe connector is connected to the signal processing module. When both of the signal receiving unit and the signal transmitting unit receive a low-level signal, the non-PCIe connector is connected to the signal processing module.

### BACKGROUND

1. Technical Field

The present disclosure relates to expansion cards, and particularly to an expansion card able to selectively activate a peripheral component interface express (PCIe) connector or a non-PCIe connector.

2. Description of Related Art

Main boards of computers have at least one PCIe slot for connecting with an expansion card, such as a graphics card or a network card. However, if the expansion card has a connector not matching the PCIe slot, the expansion card needs to be connected to the main board through an adapter card, which is inconvenient and inefficient. Furthermore, if a suitable slot is mounted on the main board for connecting a non-PCIe connector of the expansion card, the expansion card only having the non-PCIe connector can not be connected to the PCIe slot.

Therefore, it is desirable to provide an expansion card that can overcome the limitations described.

### BRIEF DESCRIPTION OF THE DRAWINGS

FIG. 1 is a functional block diagram of an embodiment of an expansion card.

FIGS. 2-6 are circuit diagrams of the expansion card of FIG. 1.

### DETAILED DESCRIPTION

Embodiments of the disclosure will be described with reference to the drawings.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

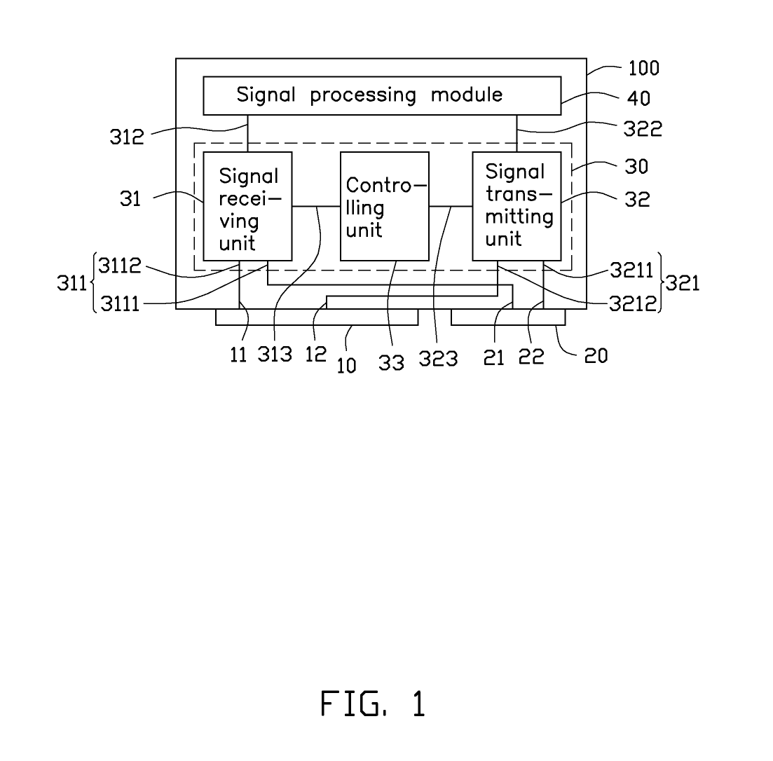

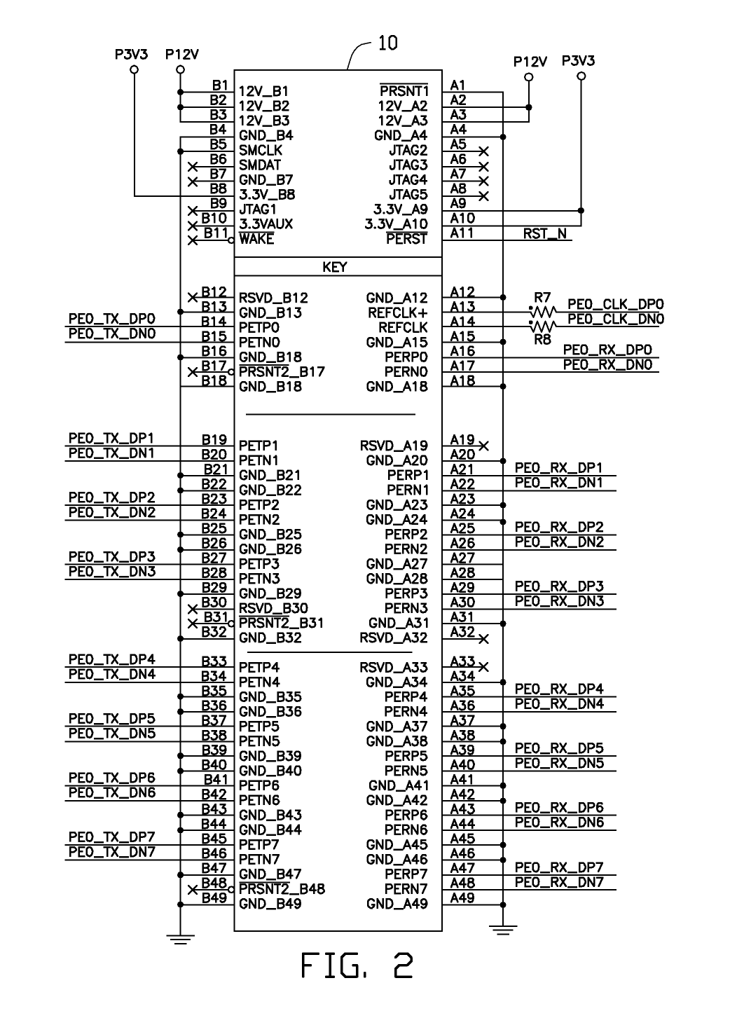

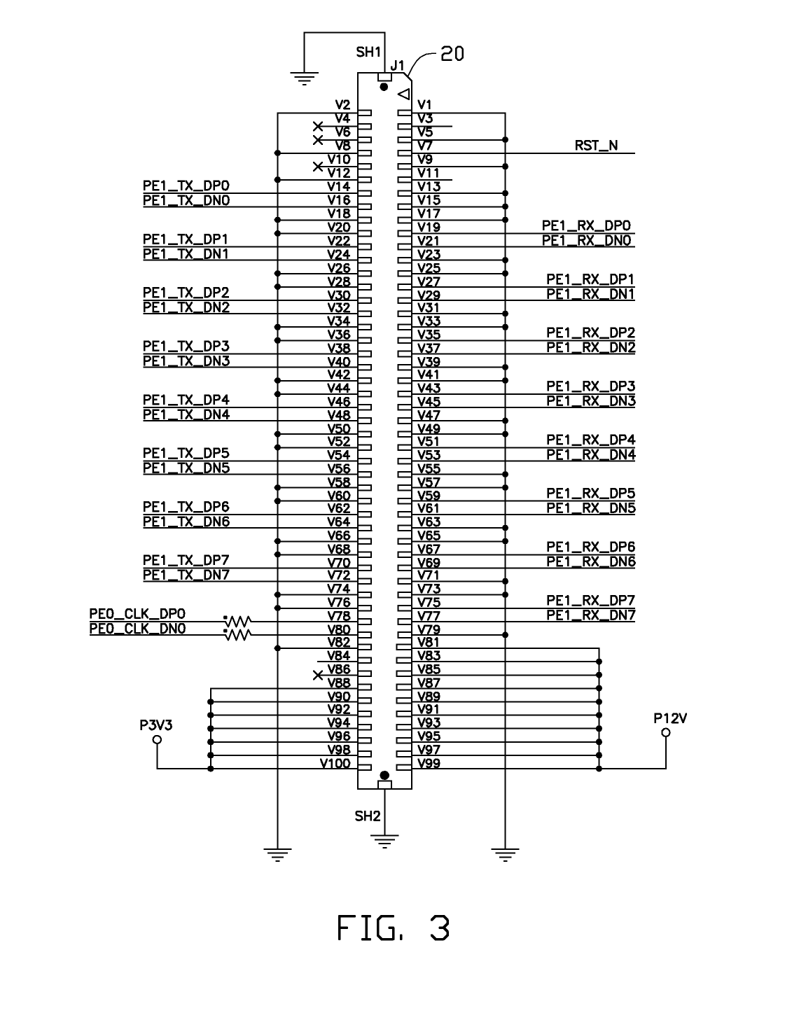

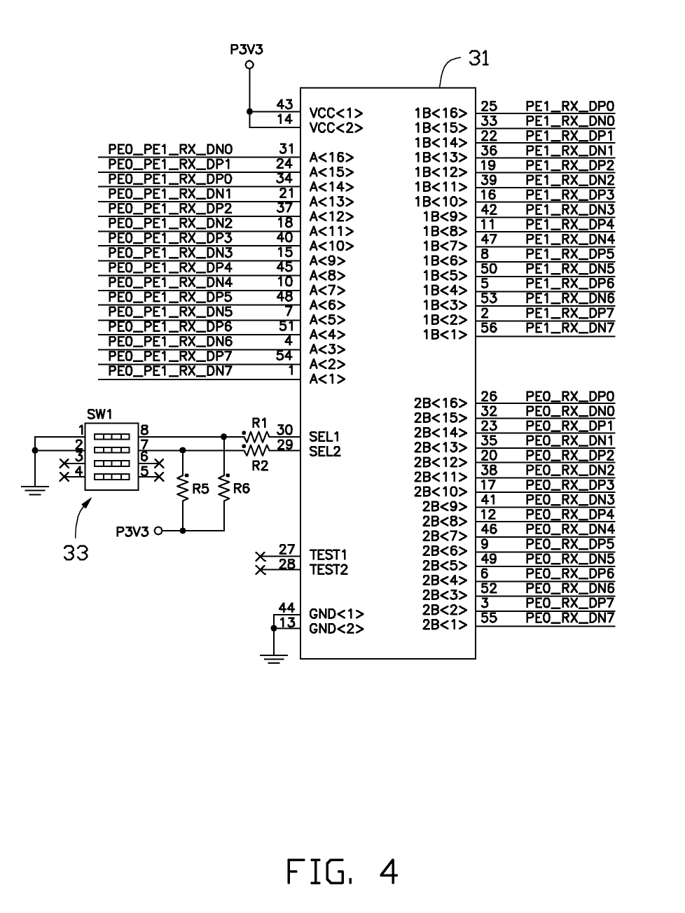

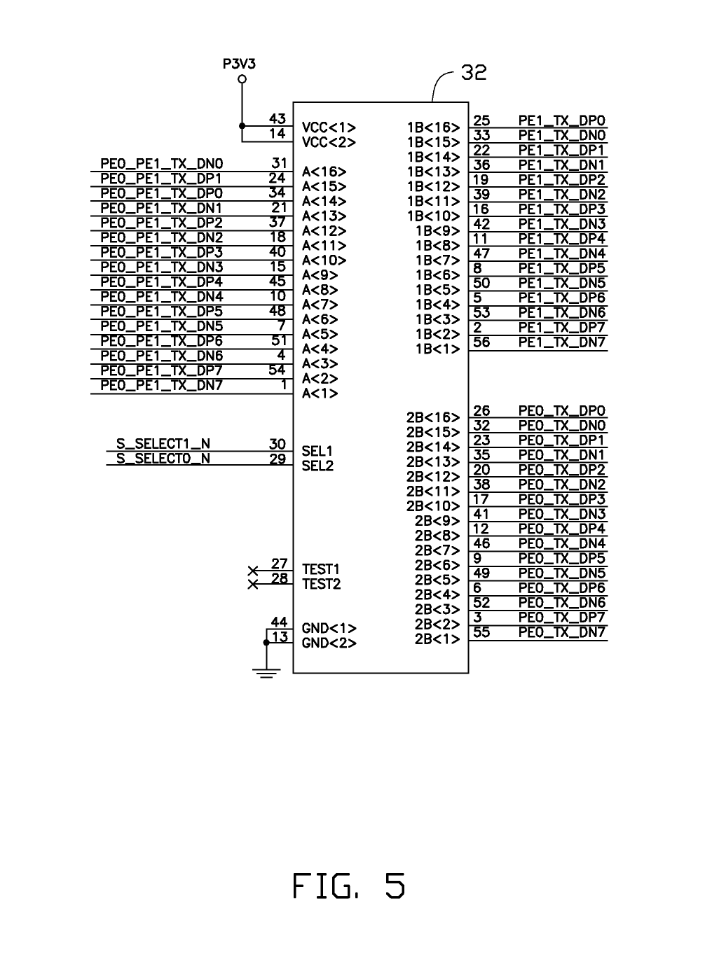

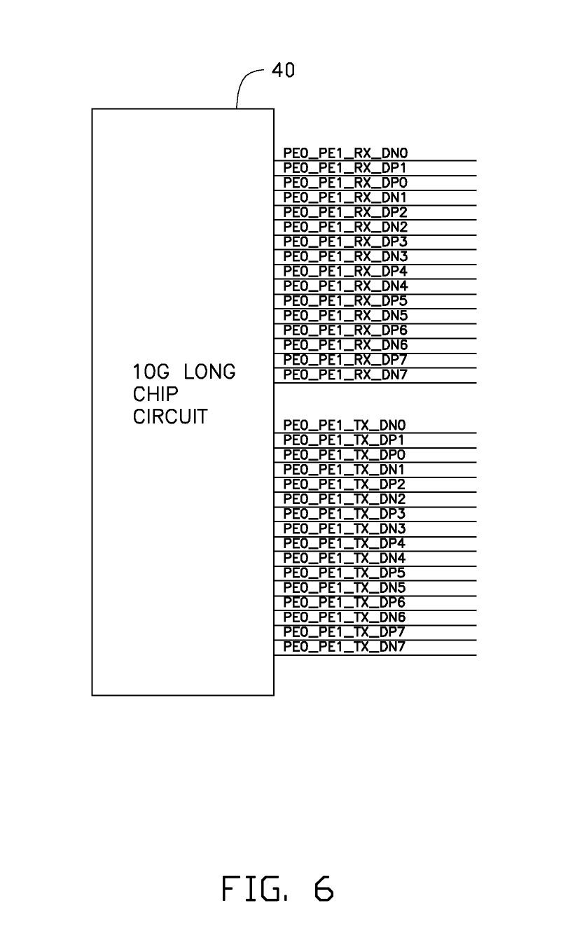

FIGS. 1-6 show an embodiment of an expansion card 100. The expansion card 100 can be, but is not limited to, a graphics card or a network card. In one embodiment, the expansion card 100 includes a PCIe connector 10, a non-PCIe connector 20, a signal switching module 30, and a signal processing module 40.

The PCIe connector 10 is pluggable into a PCIe slot having a number of standard PCIe pins. The PCIe connector 10 includes a group of first receiving terminals 11 and a group of first transmitting terminals 12. In one embodiment, the first receiving terminals 11 include sixteen pins A16, A17, A21, A22, A25, A26, A29, A30, A35, A36, A39, A40, A43, A44, A47, A48. The first transmitting terminals 12 include sixteen pins B14, B15, B19, B20, B23, B24, B27, B28, B33, B34, B37, B38, B41, B42, B45, B46.

The non-PCIe connector 20 is pluggable into a suitable slot, which is different from the PCIe slot. The non-PCIe connector 20 includes a group of second receiving terminals 21 and a group of second transmitting terminals 22. In one embodiment, the second receiving terminals 21 include sixteen pins V19, V21, V27, V29, V35, V37, V43, V45, V51, V53, V59, V61, V67, V69, V75, V77. The second transmitting terminals 22 include sixteen pins V14, V16, V22, V24, V30, V32, V38, V40, V46, V48, V54, V56, V62, V64, V70, V72.

The signal switching module 30 includes a signal receiving unit 31, a signal transmitting unit 32, and a controlling unit 33. The signal receiving unit 31 and the signal transmitting unit 32 are two same switching chips U1, U2. The signal receiving unit 31 is configured for selectively receiving signals from the PCIe connector 10 or the non-PCIe connector 20. The signal transmitting unit 32 is configured for selectively transmitting signals to the non-PCIe connector 20.

The signal receiving unit 31 includes a group of first inputting terminals 311, a group of second inputting terminal 312, and a group of first controlling terminals 313. The first inputting terminals 311 include a group of first sub-inputting terminals 3111 and a group of second sub-inputting terminals 3112. When the first controlling terminals 313 receive a low-level signal, such as 0 volts (V), the first sub-inputting terminals 3111 are connected to the second inputting terminals 312, and the second sub-inputting terminals 3112 are disconnected from the second inputting terminals 312. When the first controlling terminals 313 receive a high-level signal, such as +5 V, the second sub-inputting terminals 3112 are connected to the second inputting terminals 312, and the first sub-inputting terminals 3111 are disconnected from the second inputting terminals 312. In one embodiment, the first sub-inputting terminals 3111 include sixteen pins 1B1, 1B2, 1B3, 1B4, 1B5, 1B6, 1B7, 1B8, 1B9, 1B10, 1B11, 1B12, 1B13, 1B14, 1B15, 1B16. The second sub-inputting terminals 3112 include sixteen pins 2B1, 2B2, 2B3, 2B4, 2B5, 2B6, 2B7, 2B8, 2B9, 2B10, 2B11, 2B12, 2B13, 2B14, 2B15, 2B16. The second inputting terminals 312 include sixteen pins A1, A2, A3, A4, A5, A6, A7, A8, A9, A10, A11, A12, A13, A14, A15, A16.

The signal transmitting unit 32 includes a group of first outputting terminals 321, a group of second outputting terminals 322, and a group of second controlling terminals 323. The first outputting terminals 321 include a group of first sub-outputting terminals 3211 and a group of second sub-outputting terminals 3212.

When the second controlling terminals 323 receive a low-level signal, such as 0 V, the first sub-outputting terminals 3211 are connected to the second outputting terminals 322, and the second sub-outputting terminals 3212 are disconnected from the second outputting terminals 322. When the second controlling terminals 323 receive a high-level signal, such as +5 V, the second sub-outputting terminals 3212 are connected to the second outputting terminals 322, and the first sub-outputting terminals 3211 are disconnected from the second outputting terminals 322. In one embodiment, the first sub-outputting terminals 3211 include sixteen pins 1B1, 1B2, 1B3, 1B4, 1B5, 1B6, 1B7, 1B8, 1B9, 1B10, 1B11, 1B12, 1B13, 1B14, IBIS, 1B16. The second sub-outputting terminals 3212 include sixteen pins 2B1, 2B2, 2B3, 2B4, 2B5, 2B6, 2B7, 2B8, 2B9, 2B10, 2B11, 2B12, 2B13, 2B14, 2B15, 2B16. The second outputting terminals 322 include sixteen pins A1, A2, A3, A4, A5, A6, A7, A8, A9, A10, A11, A12, A13, A14, A15, A16.

In one embodiment, the controlling unit 33 is a toggle switch, which is connected to the first controlling terminals 313 and the second controlling terminals 323. The controlling unit 33 outputs either the low-level signal or the high-level signal to the first controlling terminals 313 and the second controlling terminals 323.

The signal processing module 40 is connected to the second inputting terminals 312 and the second outputting terminals 322. In one embodiment, the signal processing module 40 is a local area network circuit.

The first receiving terminals 11 of the PCIe connector 10 are connected to the second sub-inputting terminals 3112 of the signal receiving unit 31. The second receiving terminals 21 of the non-PCIe connector 20 are connected to the first sub-inputting terminals 3111 of the signal receiving unit 31. The first transmitting terminals 12 of the PCIe connector 10 are connected to the second sub-outputting terminals 3212 of the signal transmitting unit 32. The second transmitting terminals 22 of the non-PCIe connector 20 are connected to the first sub-outputting terminals 3211 of the signal transmitting unit 32.

In one embodiment, the pins A16, A17, A21, A22, A25, A26, A29, A30, A35, A36, A39, A40, A43, A44, A47, A48 of the PCIe connector 10 are connected to the pins 2B1, 2B2, 2B3, 2B4, 2B5, 2B6, 2B7, 2B8, 2B9, 2B10, 2B11, 2B12, 2B13, 2B14, 2B15, 2B16 of the signal receiving unit 31, respectively. The pins V19, V21, V27, V29, V35, V37, V43, V45, V51, V53, V59, V61, V67, V69, V75, V77 of the non-PCIe connector 20 are connected to the pins 1B1, 1B2, 1B3, 1B4, 1B5, 1B6, 1B7, 1B8, 1B9, 1B10, 1B11, 1B12, 1B13, 1B14, 1B15, 1B16 of the signal receiving unit 31, respectively. The pins B14, B15, B19, B20, B23, B24, B27, B28, B33, B34, B37, B38, B41, B42, B45, B46 of the PCIe connector 10 are connected to the pins 2B1, 2B2, 2B3, 2B4, 2B5, 2B6, 2B7, 2B8, 2B9, 2B10, 2B11, 2B12, 2B13, 2B14, 2B15, 2B16 of the signal transmitting unit 32, respectively. The pins V14, V16, V22, V24, V30, V32, V38, V40, V46, V48, V54, V56, V62, V64, V70, V72 of the non-PCIe connector 20 are connected to the pins 1B1, 1B2, 1B3, 1B4, 1B5, 1B6, 1B7, 1B8, 1B9, 1B10, 1B11, 1B12, 1B13, 1B14, 1B15, 1B16 of the signal transmitting unit 32, respectively.

In use, when the non-PCIe connector 20 of the expansion card 100 is plugged into a non-PCIe slot of a main board (not shown), the controlling unit 33 outputs the low-level signal, the first sub-inputting terminals 3111 are connected to the second inputting terminals 312, and the first sub-outputting terminals 3211 are connected to the second outputting terminals 322. Therefore, the non-PCIe connector 20 is connected to the signal processing module 40. When the PCIe connector 10 of the expansion card 100 is plugged into a PCIe slot of the main board, the controlling unit 33 outputs a high-level signal, the second sub-inputting terminals 3112 are connected to the second inputting terminals 312, and the second sub-outputting terminals 3212 are connected to the second outputting terminals 322. Therefore, the PCIe connector 10 is connected to the signal processing module 40.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An expansion card, comprising:
a PCIe connector comprising a group of first receiving terminals and a group of first transmitting terminals;
a non-PCIe connector comprising a group of second receiving terminals and a group of second transmitting terminals;
a signal switching module, comprising:
a signal receiving unit comprising a group of first inputting terminals and a group of second inputting terminal;
a signal transmitting unit comprising a group of first outputting terminals and a group of second outputting terminal;
wherein the first receiving terminals and the second receiving terminals are connected to the first inputting terminals, the first transmitting terminals and the second transmitting terminals are connected to the first outputting terminals;
a signal processing module connected to the second inputting terminals and the second outputting terminals;
wherein when both of the signal receiving unit and the signal transmitting unit receive a low-level signal, the second receiving terminals and the second transmitting terminals are connected to the second inputting terminals and the second outputting terminals; when both of the signal receiving unit and the signal transmitting unit receive a high-level signal, the first receiving terminals and the first transmitting terminals are connected to the second inputting terminals and the second outputting terminals.

2. The expansion card of claim 1, wherein the first inputting terminals comprise a group of first sub-inputting terminals and a group of second sub-inputting terminals, the first sub-inputting terminals are connected to the second receiving terminals, the second sub-inputting terminals are connected to the first receiving terminals.

3. The expansion card of claim 2, wherein the first outputting terminals comprise a group of first sub-outputting terminals and a group of second sub-outputting terminals, the first sub-outputting terminals are connected to the second transmitting terminals, the second sub-inputting terminals are connected to the first transmitting terminals.

4. The expansion card of claim 3, wherein when both of the signal receiving unit and the signal transmitting unit receive a low-level signal, the first sub-inputting terminals are connected to the second inputting terminals and the first sub-outputting terminals are connected to the second outputting terminals; when both of the signal receiving unit and the signal transmitting unit receive a high-level signal, the second sub-inputting terminals are connected to the second inputting terminals and the second sub-outputting terminals are connected to the second outputting terminals.

5. The expansion card of claim 1, wherein the signal receiving unit comprises a first controlling terminal, the signal transmitting unit comprises a second controlling terminal, the signal switching module comprises a controlling unit, the controlling unit is connected to the first controlling terminal and the second controlling terminal.

6. An expansion card, comprising:
a PCIe connector;
a non-PCIe connector;
a signal switching module comprising a signal receiving unit and a signal transmitting unit; the PCIe connector connected to the signal receiving unit and the signal transmitting unit, the non-PCIe connector connected to the signal receiving unit and the signal transmitting unit; and
a signal processing module connected to the signal receiving unit and the signal transmitting unit;
wherein when both of the signal receiving unit and the signal transmitting unit receive a high-level signal, the PCIe connector is connected to the signal processing module; when both of the signal receiving unit and the signal transmitting unit receive a low-level signal, the non-PCIe connector is connected to the signal processing module.
